(19) United States
(12) Patent Application Publication
(10) Pub. No.: US 2010/0313823 A1
(43) Pub. Date: Dec. 16, 2010

(54) Safe habitat feline play apparatus

(76) Inventor: Shannon Swedberg, Owatonna, MN (US)

Correspondence Address: Gary L. Huusko, Suite 600, 7300 West 147th Street, Apple Valley, MN, 55124, US

(21) Appl. No.: 12/456,207

(22) Filed: Jun. 12, 2009

(51) Int. Cl. A01K 1/00; A01K 1/03

(52) U.S. Cl. 119/474; 119/452; 119/481

(57) ABSTRACT

A safe, outdoor habitat is provided where an indoor cat can spend a few hours of its day outdoors in a relative safe environment. The habitat comprises a frame, a plurality of screened vertical panels, a screened top panel, and a climbable member, the frame being made of a durable material such as untreated cedar. The vertical and top screened panels are removable secured to the frame such that the structure defines a screened geometric structure. Doors are situated on one of the vertical panels, thereby defining a front of the structure with an entrance. Thus a house cat can be safely and securely placed within the habitat structure by its owner; the cat can roam within the habitat structure and experience the outdoors; and the cat can climb the climbing member while the owner can monitor and view the activities of the cat through the animal resistant screen.

### FIELD OF INVENTION

The invention relates generally to a safe play area for domesticated house cats, and more particularly, to an easily assembled habitat structure having sufficient area, play and safety features to allow house cats a seemingly natural environment to play outdoors safely.

### PRIOR ART

Pet carriers and cages are well known, and many varied types are also well known and practiced.

Travel cages, scratching posts, and other enclosure-type facilities are also known for use by pets and pet owners, including by cat owners for their domestic pet cat. None, however, combine the features that allow for a house cat to experience the freedom of the outdoors in a safe, yet playful environment. None of the existing art offers an outdoor experience that caters to the natural senses and desires of the indoor cat in a safe, cat friendly way or provides peace of mind to the cat owner who wishes to enhance their cat's life.

U.S. Pat. No. 5,551,372 to Nichols is an example of a fenced area to restrict the movement and travel of pets so that they do not damage or harm the environment. Nichols discloses a large modular fenced area that attaches to a house, and that contains a living area for cats or other animals, restricting their movement so that the animal cannot damage or harm the surrounding flora or fauna. A variety of pens are disclosed, each being attached to another pen, so as to enlarge the area within which the pet or animal may wander.

Similarly, U.S. Pat. No. 7,293,530 to Italiano discloses a series of lightweight, easily transportable identical frame pieces attached together to form an expandable pet enclosure that can be assembled into a multiplicity of configurations, optionally with a floor or a roof that comprises the same frame pieces, in essence, an adjustable fencing to define an area for a pet to wander.

Other prior art includes pet carriers and pet housing-type structures such as a sectional cage of U.S. Pat. No. 6,763,784 to Liu; the animal shelter of U.S. Pat. No. 1,887,108 to Steese; the collapsible house for cats using an A-frame type structure of U.S. Pat. No. 4,576,116 to Binkert; the self-covering pet bed of U.S. Pat. No. 5,000,116 to Fife; the collapsible animal enclosure of U.S. Pat. No. 5,335,618 to Zarola; then potable animal enclosure of U.S. Pat. No. 6,688,256 to King; the pet tent which includes a collapsible tent for housing a pet of U.S. Pat. No. 6,715,446 to Chou; the erectable and collapsible portable structure of U.S. Pat. No. 6,851,136 to Brereton; the collapsible container for housing and carrying pets of U.S. Pat. No. 5,078,096 to Bishop; the pop-up pet carrier of U.S. Pat. No. 6,899,057 to Chrisco; and the pet carrier which seems to be configured in the shape of a pup tent with a translucent meshing and a handle on the roof of the tent to allow the owner to carry the pet and the carrier of U.S. D469,929 to Licciardello.

The disadvantages of the prior art mentioned above include the size of the structure, it is either too small to allow the house cat to freely roam within a controlled environment or too large to be easily portable, the ease of use or set-up, and the beneficial features available for a healthy and happy pet.

The present invention is directed towards overcoming these problems.

### DISCLOSURE OF THE INVENTION

According to the invention, a safe, outdoor enclosure is provided where an indoor cat can spend a few hours of its day sans leash and harness comprising a habitat structure, the habitat structure comprising a frame of durable material, a front and a back, and two sides, a top, and attaching means to attach the front and back to the sides and the top to the front, back and two sides. The back and two sides comprise animal resistant screen mesh and the front comprises the same animal resistant screen mesh with a door for ingress and egress. The frame can be made of any durable material; however, the preferred embodiment would use untreated cedar. The attaching means comprise removably attaching means, such as screws, clips and the like, such that the top could be removed, as could the front, back and either or both sides, for ease of assembly and disassembly, and for easy portability. The front and back when removably attached to the sides form a rectangular prism-like structure. The top, front, back and sides are separate pieces that are intended to be constructed and assembled with ease. Thus, the habitat structure could be placed in a yard, on a deck or patio, or anywhere the pet owner wants his or her cat to experience the freedom of the outdoors in safety.

Within the habitat structure is a unique feature of a designed tree in the center that can be artificial, living, or an already deceased tree. For example the Tamarac tree is an extremely hard and resistant to rot tree that can be used. The design tree can have a step-stool feature or a series of steps to help a declawed or mature pet to climb and experience the full benefits of the habitat structure. The design tree offers a cat the ultimate outdoor experience by allowing it to climb and perch while enjoying outdoor life—high enough to feel safe from other animals and to evoke the feeling of the hunt that is so delightful to cats by nature, yet safely within a protective structure.

The habitat structure would not have a bottom, instead it would be secured to the ground by stakes or the like, thus allowing the natural ground, such as grass, to be experienced by the cat. Alternatively, the habitat structure could be placed upon other pet-safe ground coverings, such as cedar chips and the like.

It will be appreciated that an advantage of this invention is that the habitat structure is durable, easily assembled and easily placed in any area that the pet owner would like to have his or her cat experience the outdoors while being in a safe environment.

Further advantages include the ability to easily disassemble the habitat structure to move it to any desired location, and that its simple structure allows it to be easily manufactured to a variety of sizes to suit every pet owner's situation, including a travel-sized option.

### BRIEF DESCRIPTION OF DRAWINGS

FIG. 1 is a perspective view of the front of the habitat structure.

FIG. 2 is a front view of the habitat structure.

FIG. 3 is a top view of the habitat structure.

FIG. 4 is a side view of the habitat structure.

### DETAILED DESCRIPTION OF DRAWINGS AND BEST MODE FOR CARRYING OUT THE INVENTION

A safe, outdoor habitat structure enclosure is provided where an indoor cat can spend a few hours of its day outdoors in a relative safe environment.

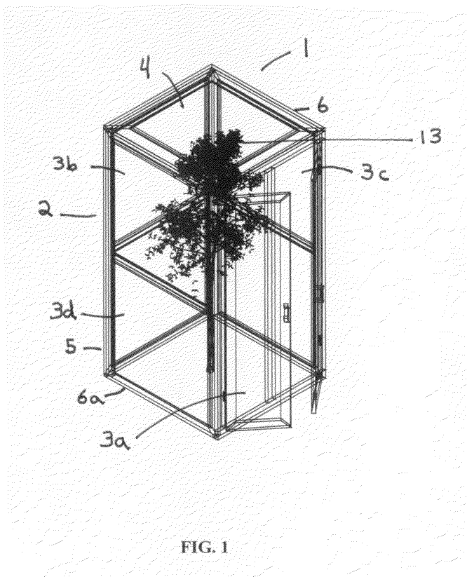

Referring to FIG. 1, the habitat structure 1 comprises a frame 2, a plurality of vertical panels 3 and a top panel 4, the frame 2 comprising a plurality of elongated vertical support members of equal length 5 and a plurality of elongated horizontal support members of an equal length 6, frame attaching means for attaching the vertical support members 5 to the horizontal support members 6 thereby defining an elongated geometric structure with a plurality of open sides, an open top and an open bottom, the elongated vertical support members 5 and horizontal support members 6 comprising a durable material, such as untreated cedar, although other durable materials may also be used.

The frame attaching means comprising removably attaching means, such as screws, clips or the like.

Referring still to FIG. 1, the top panel 4 and all but one of the vertical panels comprising animal resistant screen or mesh 7, and the remaining vertical panel comprising a pair of doors 8 to allow the pet owner to enter and exit the habitat for purposes of placing or retrieving the cat from the habitat structure. The doors 8 comprise door panels 9 of the same animal resistant screen or mesh as the other vertical panels.

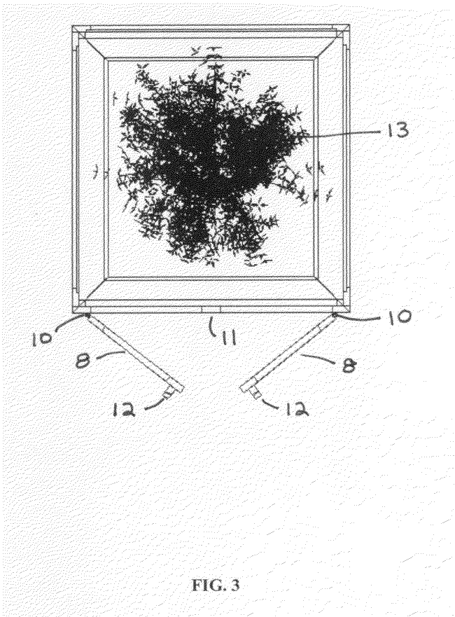

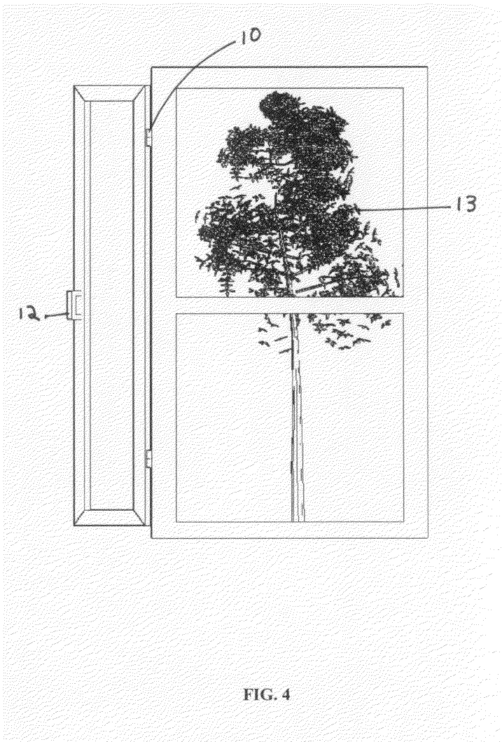

Referring to FIGS. 3 and 4, the doors 8 further comprising hinging means 10 and latching means 11 to easily open and securely close the doors. The doors would also have handles 12 that are easy to grasp by the pet owner, yet would be impossible for the cat to un-engage the latch, thereby preventing unintended escape by the cat. The animal resistant screen or mesh comprises a durable yet light and easy to see through screen material.

The habitat structure 1 would be assembled using removable panel attaching means, such as screws or clips or the like, such that the vertical panels would be attached to the open sides of the frame to form an elongated geometric structure and the top panel would be attached to the open top of the frame. The frame would also be assembled using removable attaching means, such as screws or clips or the like, to facilitate easy assembly and disassembly.

In the preferred embodiment, as shown in FIG. 1, the habitat structure 1 comprises a frame 2, a front vertical panel 3a, a back vertical panel 3b, two side vertical panels 3c and 3d and a top panel 4, the frame comprising four elongated vertical support members of equal length 5, four elongated horizontal top support members of an equal length 6 and four elongated horizontal bottom support members of an equal length 6a, attaching means for attaching the vertical support members to the horizontal support members thereby defining an elongated rectangular prism-like structure with an open front, an open back, two open sides, an open top and an open bottom. Three additional horizontal middle members of equal length may also be used to stabilize or reinforce the habitat, those horizontal middle members being situated mid-way between the horizontal top and horizontal bottom members on the back vertical and two side vertical panels. The front vertical panel would be removably attached to the open front, the back vertical panel would be removably attached to the open back, the two side vertical panels would be removably attached to the open sides and the top panel would be removably attached to the open top. In the preferred embodiment, the pair of doors would be situated on the front vertical panel.

The habitat structure would rest upon the ground, or could be placed on a patio, deck or other relatively flat surface. If placed on the ground, the habitat structure would be secured to the ground by stakes or the like. If placed upon a surface that is not conducive to staking, then a weighted base would be secured to the habitat structure, thereby preventing any tipping or unintended moving.

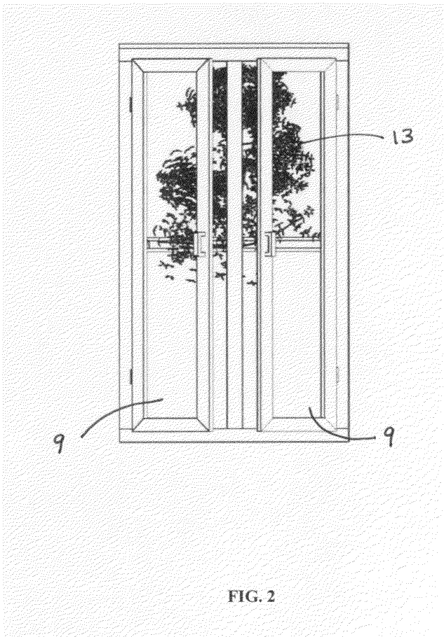

A designed tree 13, as shown is FIGS. 1, 2, 3 and 4, is situated within the habitat structure and can either rest upon the ground or flat surface, or be attached to the back, one of the sides or the top of the habitat structure to prevent unintended movement of the design tree by removable attaching means such as screws, clips or the like. The design tree would preferably be made out of real wood, such a Tamarac or another durable and rot resistant wood, or manufactured out of a wood substitute with similar qualities to natural wood. The design tree could also comprise a step-stool or series of steps allowing declawed or mature cats the ability to climb the tree.

The top panel and vertical panels, or as in the preferred embodiment, the front panel, back panel and side panels, are separate pieces that are intended to be constructed and assembled with ease. Thus, the habitat structure could be placed in a yard, on a deck or patio, or anywhere the pet owner wants his or her cat to experience the freedom of the outdoors in safety.

The habitat structure could be made to any size, depending upon the area it will be placed, or the size of the cat or desires of the pet owner. Smaller sizes would be more portable, thus allowing the pet owner to bring their cat along on trips with the habitat, eliminating the need for a sitter or other kennel-type accommodations for the pet while the owner is away.

In the preferred embodiment, the dimensions of the habitat structure would include the frame that is 7 feet 1 inch in height, 3 feet 6 inches wide and 3 feet 8 inches deep, with side panels that are sufficient in height and width to fit within the sides of the frame; the back panel of sufficient height and width to fit within the back of the frame, and the front panel with doors of sufficient height and width to fit within the front of the frame.

I claim:

1. A safe, outdoor feline habitat structure comprising:
(a) a frame
(b) a plurality of vertical panels
(c) a top panel
(d) a climbing member
(e) said frame comprising a plurality of vertical elongated support members of equal length and a plurality of elongated horizontal support members of equal length
(f) frame attaching means for attaching said elongated vertical support members to said elongated horizontal support members to form a geometric structure with a plurality of open sides, an open top and an open bottom
(g) panel attaching means for attaching said vertical panels to said frame at each open side of said frame and said top panel to said frame at the open top of said frame thereby partially enclosing the geometric structure with the vertical side panels and the top panel
(h) said climbing means situated within the enclosed geometric structure
(i) said top panel and all but one of said vertical panels comprising animal resistant screen
(j) the remaining vertical panel comprising a pair of doors, said doors each comprising a door panel, hinging means and latching means to easily open and securely close said doors, said hinging means attaching each door to the remaining vertical panel and said latching means attached to each door to securely close said doors
(k) each door panel comprising animal resistant screen and
(l) said vertical elongated support members and horizontal elongated support members comprising a durable material
whereby a house cat can be securely placed into the habitat structure by its owner by use of the doors and the cat can climb the climbing member while the owner can monitor and view the activities of the cat through the animal resistant screen.

2. The structure of claim 1 wherein the vertical elongated support members of equal length number four, and the elongated horizontal support members of equal length number eight.

3. The structure of claim 1 wherein the plurality of vertical panels comprise a front vertical panel, a back vertical panel, and two side vertical panels.

4. The structure of claim 3 wherein the front vertical panel comprises the pair of doors, the doors each comprising said door panel, hinging means and latching means to easily open and securely close the doors, said hinging means attaching each door to the front vertical panel and said latching means attached to each door to securely close the doors.

5. The structure of claim 1 wherein the durable material of said vertical elongated support members and horizontal elongated support members is untreated cedar.

6. The structure of claim 1 wherein the frame attaching means comprises removably attaching means.

7. The structure of claim 1 wherein the panel attaching means comprises removably attaching means.

8. The structure of claim 1 wherein the climbing member is a tree shaped structure.

9. The structure of claim 1 wherein the climbing member is a natural tree.

10. The structure of claim 1 wherein the climbing member is in the shape of a tree trunk with branches.

11. The structure of claim 1 wherein the climbing member is a manufactured wood product in the shape of a tree trunk with branches.

12. The structure of claim 1 wherein the climbing member further comprises a series of steps whereby a declawed or mature cat can easily climb the climbing member.

13. The structure of claim 1 wherein the climbing member further comprises a step-stool whereby a declawed or mature cat can easily climb the climbing member.

14. The structure of claim 1 wherein the climbing member is attached to the top panel.

15. The structure of claim 1 wherein the climbing member is attached to one of the vertical panels.

16. The structure of claim 1 wherein the assembled structure is 7 feet 1 inch in height, 3 feet 6 inches wide and 3 feet 8 inches deep.

17. A safe, outdoor feline habitat structure comprising:
(a) a frame made of a durable material
(b) a front vertical panel, a back vertical panel, and two side vertical panels
(c) a top panel
(d) a wooden tree shaped climbing member secured within the structure, the climbing member further comprising a series of steps whereby a declawed or mature cat can easily climb the climbing member
(e) said frame comprising four vertical elongated support members of equal length and eight elongated horizontal support members of equal length
(f) frame attaching means for attaching said elongated vertical support members to said elongated horizontal support members to form a geometric structure with a plurality of open sides, an open top and an open bottom
(g) panel attaching means for attaching said vertical panels to said frame at each open side of said frame and said top panel to said frame at the open top of said frame thereby partially enclosing the geometric structure with the vertical side panels and the top panel
(h) said climbing means situated within the enclosed geometric structure
(i) said top panel, back vertical panel and two side vertical panels comprising animal resistant screen
(j) said front vertical panel comprising a pair of doors, said doors each comprising a door panel, hinging means and latching means to easily open and securely close said doors, said hinging means attaching each door to the front vertical panel and said latching means attached to each door to securely close said doors
(k) each door panel comprising animal resistant screen and
(l) said vertical elongated support members and horizontal elongated support members comprising a durable material
whereby a house cat can be securely placed into the habitat structure by its owner by use of the doors and the cat can climb the climbing member while the owner can monitor and view the activities of the cat through the animal resistant screen.

18. The structure of claim 17 wherein the durable material of said vertical elongated support members and horizontal elongated support members is untreated cedar.

19. The structure of claim 17 wherein the frame attaching means and panel attaching means comprise removably attaching means.

20. The structure of claim 17 wherein the assembled structure is 7 feet 1 inch in height, 3 feet 6 inches wide and 3 feet 8 inches deep.
